(19) United States
(12) Patent Application Publication
(10) Pub. No.: US 2024/0351101 A1
(43) Pub. Date: Oct. 24, 2024

(54) ARTICLE MANUFACTURE

(71) Applicant: ROLLS-ROYCE SUBMARINES LIMITED, Derby (GB)

(72) Inventors: John L. SULLEY, Derby (GB); David A. STEWART, Derby (GB)

(73) Assignee: ROLLS-ROYCE SUBMARINES LIMITED, Derby (GB)

(21) Appl. No.: 18/611,196

(22) Filed: Mar. 20, 2024

(30) Foreign Application Priority Data
Apr. 19, 2023 (GB) 2305716.9

(51) Int. Cl. B22F 3/15; B22F 1/145; G21C 13/087

(52) U.S. Cl. CPC B22F 3/15; B22F 1/145; G21C 13/087; B22F 2201/013; B22F 2301/35; B22F 2302/25; B22F 2998/10

(57) ABSTRACT

A method for manufacturing an article, e.g. a nuclear pressure vessel. The method involves: a) charging at least one hopper with steel powder; b) supplying an oxide stripping medium to the steel powder in the at least one hopper; c) removing the oxide stripping medium and any oxide particles stripped from the steel powder from the at least one hopper; d) discharging the oxide stripped steel powder into a can that provides a mould for the article; and e) converting the steel powder to solid steel by hot isostatic pressing to form the article. Stripping the steel powder of oxides whilst the steel powder is in the at least one hopper optimises desirable material properties of the article and thereby quality and safety of the article.

### CROSS-REFERENCE TO RELATED APPLICATIONS

This specification is based upon and claims the benefit of priority from United Kingdom patent application number GB 2305716.9 filed on Apr. 19 2023, the entire contents of which is incorporated herein by reference.

### BACKGROUND

### Field of the Disclosure

The present disclosure relates to a method for manufacturing an article. More specifically a method for manufacturing an article such as a vessel, e.g. a nuclear reactor pressure vessel, from a powder, e.g. a steel powder.

### Description of the Related Art

Hot isostatic pressing is typically used to manufacture articles or to modify the physical properties of articles.

Articles that manufactured using hot isostatic pressing process are typically formed from a metallic powder contained within a “can”. High pressure and temperature is applied to the can in order to form the powder into a solid construct. The can is subsequently removed by machining or pickling to reveal the required shape of the article.

Articles that are used in safety critical or mission critical applications invariably require their material properties to be of a very high quality in order to provide the necessary strength to withstand the loads applied to them in-service. Furthermore, the required strength of the material must readily and reliably repeatable when manufacturing a number of the same articles. The material quality and strength must be guaranteed every time that the article is manufactured.

As an example, the article may be a nuclear reactor pressure vessel, which is typically used within a nuclear power plant to safely and effectively contain a nuclear coolant, a core shroud and a reactor core. It must be constructed to withstand the extreme conditions expected in operation. The required safety of operation is especially extreme given the very significant implications of any failure by the nuclear pressure vessel or the nuclear power plant generally.

Articles such as nuclear pressure vessels are commonly extremely expensive to manufacture, they can be large and of a complex geometry, and can take a considerable time to produce. Thus, if the required material properties are not achieved, the article cannot be used and is then scrapped. The actual material properties that are achieved on each article can only be ascertained towards the end of the manufacturing sequence after the material has been formed following a significant number of value-adding activities. Thus, when scrapped, all the previous operations conducted to form the article are nugatory resulting in significant financial loss, waste, and production delays.

The material properties of the article, i.e. quality, are commonly ascertained by taking a sample of material from an accessible part of the formed article which can be easily removed, and testing this sample. It is imperative that the sample taken is representative of the rest of the material of the article. An article integrity issue, leading potentially to a safety issue, can arise if, for example, the sample taken is tested and produces good property results, but there are other areas of the article that cannot be tested and have inferior material properties. For safety critical and mission critical applications, the manufacturer of the article must be able to substantiate that the sample taken is representative of all areas of the article in order to provide a justification to enable the article to be used in service. If this cannot be provided, then the method of manufacture and article cannot be justified and used.

It is known to use hot isostatic pressing to manufacture metal or ceramic articles that have desirable mechanical properties. This typically involves providing a can that is shaped to represent the final or near-net shape of the article. The can is typically filled with metallic or ceramic powder and then subjected to elevated temperature and isostatic gas pressure in a high-pressure consolidation vessel. The can deforms from the pressure exerted in the high-pressure consolidation vessel to consolidate the powder into a solid construct. The material quality, i.e. the mechanical properties, of the HIPed consolidated article is fundamentally dependent upon the quality of the powder in the can prior to the high pressure and temperature being applied in the HIP consolidation vessel. If the powder is of poor quality, then the final material properties of the article will be poor.

A recognised problem in the hot isostatic pressing of articles is the degradation of metal powder brought about by the unwanted presence and uptake of oxygen and the resulting formation of oxides on the powder particles, which creates powder of poor quality, and hence poor material properties in the consolidated article. Proposed solutions include the stripping of oxides formed within the aforementioned can after it has been filled with the powder metal. Research teams have attempted such oxygen stripping using cans containing the powder that have simple geometries such as cylindrical billets with varying degrees of success, and generally with relatively small quantities of powder being treated. However, the effective stripping of oxygen from large and complex cans, particularly so where large quantities of powder need to be treated effectively, remains a significant challenge, e.g. in terms of accessing all areas of the article, removing all oxides, and uniformly treating all portions of the article.

The present disclosure provides a method for manufacturing an article that overcomes at least some of the aforementioned problems or at least provides a useful alternative to known methods for manufacturing HIPed articles.

### SUMMARY OF THE DISCLOSURE

The present disclosure provides a method for manufacturing an article.

According to a first aspect there is provided a method for manufacturing a vessel, the method comprises the steps of:
a) charging at least one hopper with steel powder;
b) supplying an oxide stripping medium to the steel powder in the at least one hopper;
c) removing the oxide stripping medium and any oxide particles stripped from the steel powder from the at least one hopper;
d) discharging the oxide stripped steel powder into a can that provides a mould for the article; and
e) converting the steel powder to solid steel by hot isostatic pressing to form the article.

The method involves oxide stripping steel powder particles within the hopper rather than within the can. This is in contrast to known methods that involve oxide stripping powders when the powder has been discharged into a can and the oxide stripping medium, the stripped oxides and any by-products of the stripping process remain with the powder throughout the HIP consolidation process.

In some embodiments, the oxide stripping medium is hydrogen gas.

In some embodiments, the at least one hopper is a plurality of hoppers.

In some embodiments, the at least one hopper is frustoconical in shape.

In some embodiments, the at least one hopper includes a mixing apparatus.

In some embodiments, the at least one hopper is rotatable about an axis.

In some embodiments, the oxide stripping medium and oxide particles stripped from the steel powder are removed from the at least one hopper through an oxide stripping medium and oxide particles exit port formed in the at least one hopper.

In some embodiments, the oxide stripped steel powder is discharged through a powder exit port formed in the at least one hopper into the can.

In some embodiments, the oxide stripped steel powder is discharged from a plurality of hoppers into the can through a plurality of powder exit ports formed in the plurality of hoppers and a plurality of powder inlets formed in the can.

In some embodiments, the powder inlets are substantially equally spaced apart in order to evenly fill the can with the oxide stripped steel powder.

In some embodiments, the article is a vessel.

In some embodiments, the vessel is a nuclear reactor pressure vessel.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

The term “article” as used herein means a raw material shaped form that is subsequently processed, e.g. machined, to create a product that is used in an application, or a semi-finished form that is subsequently processed, e.g. machined, to create a product that is used in an application, or the final finished form of a product that is used in an application. The article may be a vessel, e.g. a nuclear reactor pressure vessel.

The term “oxide stripping medium” as used herein means a solid, a fluid, or a gas that can remove an oxide from a steel powder particle.

The term “steel” as used herein means an alloy of iron and carbon that typically has greater strength and fracture resistance than iron alone.

The term “carbon steel” as used herein means a steel that contains no elements other than iron and carbon, excepting negligible traces via slight impurities.

The term “alloy steel” as used herein means a steel that contains one or more elements in addition to iron and carbon. Such additional elements typically include one or more of boron, chromium, cobalt, manganese, molybdenum, nickel, niobium, titanium, tungsten, and vanadium.

The term “low alloy steel” as used herein means a steel that does not contain any significant number or quantity of additional elements that may otherwise be added to improve the mechanical properties of the steel.

The term “high alloy steel” as used herein means a steel that contains additional elements that have been added to improve the mechanical properties of the steel. Such elements typically include one or more of boron, chromium, cobalt, manganese, molybdenum, nickel, niobium, titanium, tungsten, and vanadium.

The term “hot isostatic pressing” (aka HIP or HIPing) as used herein is a manufacturing process that is used to form articles from metal or ceramic powder. The process typically involves subjecting a can filed with powder to both elevated temperature (e.g. 480 to 1230° C.) and isostatic gas pressure in a high-pressure consolidation vessel. The pressurising gas is typically an inert gas e.g. argon.

The term “can” as used herein is a receptacle or vessel that is suitable for containing powder, e.g. metallic or ceramic powder, and that is placed in a HIP consolidation vessel and deformed by the application of high pressure and high temperature to form the powder together as part of the HIP process. The can is typically shaped to represent the final shape or near-nett shape of the geometry of a desired article.

The term “hopper” as used herein is a receptacle/vessel that is suitable for containing a powder prior to powder being poured into a can. Unlike a can, a hopper is not placed in the HIP consolidation vessel and deformed as part of the HIP process.

Throughout this specification and in the claims that follow, unless the context requires otherwise, the word “comprise” or variations such as “comprises” and “comprising”, will be understood to imply the inclusion of a stated integer or group of integers but not the exclusion of any other stated integer or group of integers.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### BRIEF DESCRIPTION OF THE DRAWINGS

Embodiments will now be described by way of example only, with reference to the Figures, in which:

FIG. 1 is a schematic representation of an article in the form of a vessel, more particularly a nuclear reactor pressure vessel, that is manufactured by the method of the present disclosure;

FIG. 2 is schematic representation of equipment, including several hoppers and a can, which are used to manufacture the nuclear reactor pressure vessel of FIG. 1 in accordance with the method of the present disclosure;

FIG. 3 is schematic representation of a hopper that is used to treat, i.e. oxide strip, the powder prior to it being transferred to the can and, e.g. forms part of the equipment shown in FIG. 2 for manufacturing the nuclear reactor pressure vessel shown in FIG. 1 in accordance with the method of the present disclosure;

FIGS. 4A and 4B are schematic representations of an alternative hopper that is used to treat, i.e. oxide strip, the powder, e.g. in the manufacturing the nuclear reactor pressure vessel shown in FIG. 1 in accordance with the method of the present disclosure;

FIG. 5 shows the steps of the method of the present disclosure.

### DETAILED DESCRIPTION OF THE DISCLOSURE

Aspects and embodiments of the present disclosure will now be discussed with reference to the accompanying figures. Further aspects and embodiments will be apparent to those skilled in the art.

In broad terms the present disclosure provides a method for manufacturing an article.

The method comprises the steps of:
a) charging at least one hopper with steel powder;
b) supplying an oxide stripping medium to the steel powder in the at least one hopper;
c) removing the oxide stripping medium and any oxide particles stripped from the steel powder;
d) discharging the oxide stripped steel powder from the at least one hopper into a can that provides a mould for the article; and
e) converting the steel powder to solid steel by hot isostatic pressing to form the article.

The article may take various forms. It is typically composed of an alloy steel.

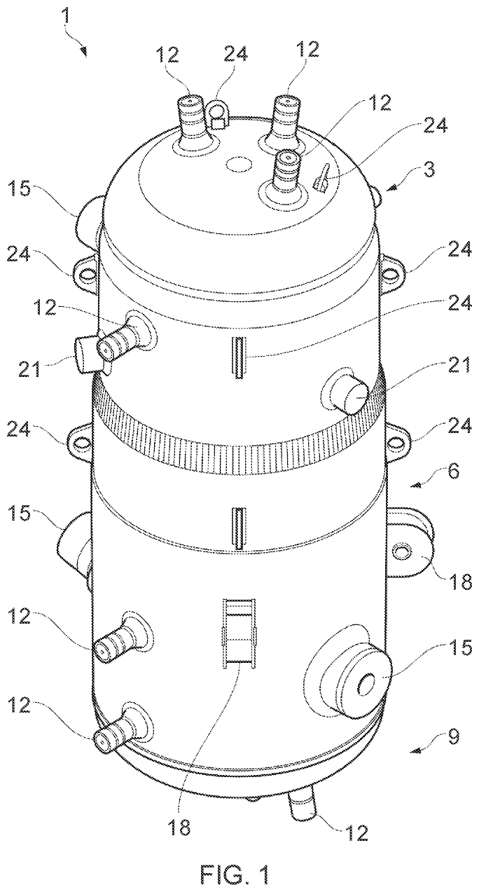

As mentioned above a recognised problem in the hot isostatic pressing of articles is the degradation of powder brought about by the unwanted presence and uptake of oxygen and the resulting formation of oxides. Such an article in the form of a vessel is schematically represented in FIG. 1. In that figure the vessel is a nuclear pressure vessel.

FIG. 1 shows a nuclear reactor pressure vessel 1 that has a top portion 3, a generally cylindrical and hollow body portion 6 and a base portion 9. The vessel has a plurality of inlet nozzles 12 through which in use a fluid, e.g. water, is supplied to the interior of the vessel and a plurality of outlet nozzles 15 through which in use the fluid is drained from the interior of the vessel. The vessel also has a plurality of lifting lugs 18 for lifting the vessel to a desired location and a plurality of support mounts 21 and support lugs 25 for mounting the vessel in its desired location.

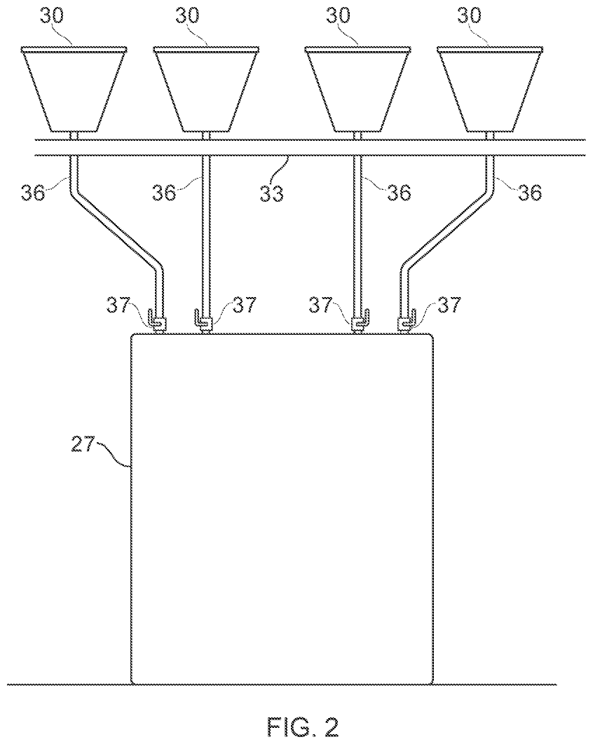

The nuclear reactor pressure vessel 1 of FIG. 1 can be manufactured by the method of the present invention using equipment shown schematically in FIG. 2. The equipment comprises a can 27 which is supplied with metal powder from a plurality of hoppers 30, which are supported on a frame 33 above the can 27, via a plurality of delivery pipes 36 that feed into a plurality of powder inlets 37 formed in the can 27.

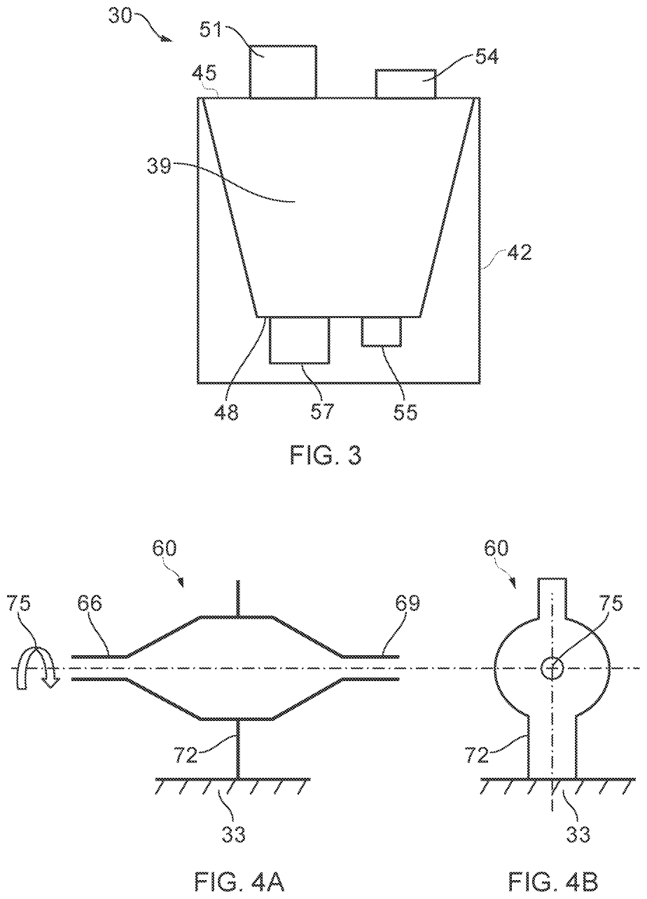

A hopper 30 is schematically represented in FIG. 3. In that figure a main hopper section 39 is housed within a hopper support frame 42. The hopper 30 has a hopper top 45 and a hopper base 48. A powder entry port 51 and an oxide stripping medium entry port 54 are provided in the hopper top 45 and a powder exit port 57 and an oxide stripping medium and oxide particles exit port 55 is provided on the hopper base 48. The positions of the entry and exit ports may be at different positions around the hopper, they do not necessarily have to be at the top and base positions as shown in FIG. 3. Additionally the entry ports 51, 54 and exit ports 55, 57 can be configured, or additional ports added, to provide for oxide stripped steel powder and/or the used oxide stripping medium and any compounds formed from any reaction between the oxide stripping medium and the steel powder to be removed from the hopper 30.

FIGS. 4A and 4B show an alternative hopper 60 that can be used to enable the oxide stripping of powder particles, e.g. in the manufacture the nuclear reactor pressure vessel 1 of FIG. 1 using the method of the present disclosure. The hopper 60 has a hopper body 63 that has a first port 66 and a second port 69. The hopper body is supported on the frame 33 by a hopper support 72. The hopper 60 is configured so that the hopper body 63 can be rotated about an axis 75. The first port 66 and the second port 69 can be configured to provide for steel powder and/or an oxide stripping medium to be supplied to the hopper 60. Alternatively or additionally the first port 66 and the second port 69 can be configured, or additional ports added, to provide for oxide stripped steel powder and/or the used oxide stripping medium and any compounds formed from any reaction between the oxide stripping medium and the steel powder to be removed from the hopper 60.

While the hopper 60 is shown in FIGS. 4A and 4B to be rotatable in an axis that is substantially parallel to the frame 33 upon which the hopper 60 sits, the hopper 60 can be configured to be rotatable in an axis that is otherwise angled with respect to the frame 33, for example substantially vertically to the frame 33.

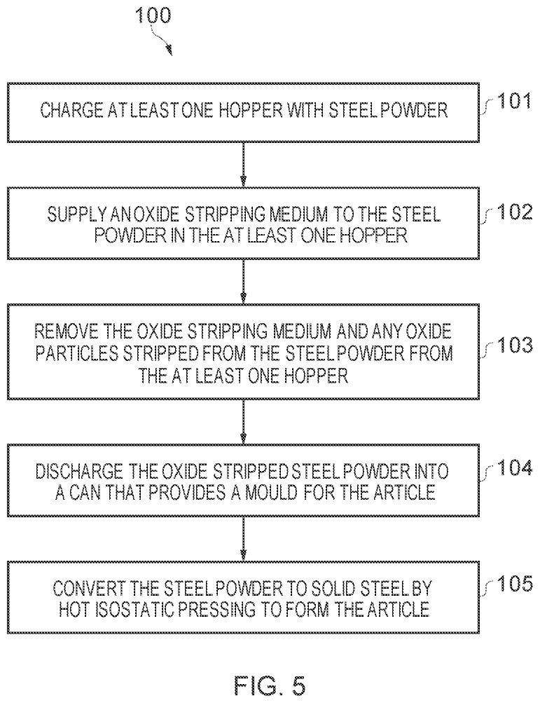

The method of the present disclosure is summarised in the flow chart of FIG. 5. The method 100 comprises steps (a)-(e) 101-105.

Step (a) 101 of the method 100 of the present disclosure involves charging at least one hopper with steel powder.

The steel powder may take various forms. In some embodiments the steel powder is a low alloy steel powder. The low alloy steel is typically a steel that complies with American Society of Mechanical Engineers Standard ASME SA508, which is a widely used steel grade for nuclear reactor pressure vessels.

The average particle size of the steel powder can vary and will typically depend on the source of the powder and the desired specifications for the article concerned e.g. the nuclear reactor pressure vessel of FIG. 1.

The hopper may take various forms. A simple hopper shape can facilitate the oxide stripping process to come, which will be described below. In some embodiments, the hopper has a frustoconical shape.

The number of hoppers employed depends on the desired article to be manufactured, more particularly the size of the article. The drawings illustrate a nuclear reactor pressure vessel and equipment for the manufacture of same. The arrangement shown in FIG. 2 has four hoppers for the manufacture of a generally cylindrical nuclear reactor pressure vessel of FIG. 1 that is about 10 metres length, 3 metres wide and weighs about 50,000 kilograms.

In the arrangement shown in FIG. 3, the steel powder is poured from a source of steel powder (not shown) into the main hopper section 39 of the hopper 30 via the powder entry port 51 that is formed in the hopper top 45 of the hopper 30. The powder hopper 39 has a simple, frustoconical shape.

Step (b) 102 of the method 100 of the present disclosure involves supplying an oxide stripping medium to the steel powder in the at least one hopper.

This is a departure from known hot isostatic pressing methods that only attempt to strip oxides from steel powder once the steel powder has been discharged into a can, i.e. prior to hot isostatic pressing. In the method of the present disclosure the steel powder is stripped of oxides whilst the steel powder is still in the hopper(s), i.e. prior to the powder being discharged into a can. In other words, in known methods the practice is to apply the oxide stripping treatment when the powder has been discharged into a can that stays with the powder through the HIP consolidation process. Whereas in the method of the present disclosure, the hopper does not accompany the powder through the HIP consolidation process.

The significance of this departure was recognised by the present inventors from as yet unpublished investigations regarding the mechanical and metallurgical properties of certain low alloy steel grade 508 alloy batches of material that were hot isostatically pressed. The Charpy impact toughness of hot isostatically pressed oxide stripped low alloy steel in particular was found to be significantly greater than forged material thus indicating that hot isostatically pressed low alloy steel can provide at least a useful alternative sourcing route to conventional forging of nuclear grade components including nuclear reactor pressure vessels.

The oxide stripping medium can take various forms. In some embodiments, the oxide stripping medium is a gas, for example hydrogen. In some embodiments the oxide stripping medium is a liquid or a solid. The key factor is that the oxide stripping medium reacts with the oxide on the steel powder to form a compound, for example water where hydrogen is used as the medium, which can be removed from the hopper leaving behind oxide free powder in the hopper.

As mentioned above, the hopper may take various forms however a simple hopper shape, e.g. a frustoconical shaped hopper (or powder hopper thereof), can facilitate the oxide stripping process. That is because it enables the oxide stripping medium to reach all powder areas easily and to more easily achieve optimal medium flow paths through the powder. It can also avoid or at least minimise any undesirable compounds, for example chemical by-products, of the oxide stripping process becoming trapped in the hopper. In some embodiments, this simple hopper shape is a frustoconical shape.

The manner in which the oxide stripping medium is supplied to the steel powder can vary as suitable. In the arrangement shown in FIGS. 2 and 3 the hopper 30 is configured to supply the oxide stripping medium in the form of hydrogen gas to the steel powder. The oxide stripping medium is supplied into the powder hopper 39 of the hopper 30 via the oxide stripping medium entry port 54 that is formed in the hopper top 45 of the hopper 30. The supply of oxide stripping medium can be monitored and controlled by suitable means that are known in the art. In some embodiments the powder and oxide stripping medium can be provided via the same entry port(s).

Step (c) 103 of the method 100 of the present disclosure involves removing the oxide stripping medium and any oxide particles stripped from the steel powder from the at least one hopper (30, 60).

The oxide stripping medium and any oxide particles stripped from the steel powder can be removed using any suitable method, for example a gas flow, evaporation, or physical cleaning of the hopper(s).

Any compounds formed from any reaction between the oxide stripping medium and/or the steel powder and/or the oxides particles, i.e. “by-product compounds”, will typically also be removed from the hopper(s) with the oxide stripping medium and any oxide particles stripped from the steel powder.

In some embodiments, the hopper 30 includes mixing equipment (not shown) to ensure a thorough mixing of oxide stripping medium within steel powder thereby maximising the stripping of oxide particles stripped from the steel powder.

In the arrangement shown in FIG. 3, the used oxide stripping medium and oxide particles (and any compounds formed from any reaction between the oxide stripping medium and/or the steel powder and/or the oxide particles) are removed from the hopper via the oxide stripping medium and oxide particles exit port 55.

In some embodiments the steel powder, the oxide stripping medium, the oxide particles and any by-product compounds can be removed via the same entry port(s). In some embodiments the entry and exit ports may be the same.

The movement of the oxide stripping medium through the steel powder and removal of the oxide stripping medium, oxide particles and compounds can be achieved by any suitable means, e.g. by gravity, or by creating a differential pressure across the hopper (e.g. by pumping the medium or by pulling a vacuum across the hopper).

In some embodiments the used oxide stripping medium is recycled to be used again in the method of the present invention.

Step (d) 104 of the method 100 of the present disclosure involves discharging the oxide stripped steel powder into a can that provides a mould for the article.

The oxide stripped steel powder can be discharged (or otherwise transferred) from the at least one hopper into a can using any suitable method.

In some embodiments, the oxide stripped steel powder is discharged from a plurality of hoppers and into a plurality of powder inlets 37 formed in the can 27. In some embodiments, these powder inlets 37 are substantially equally spaced apart, e.g. around the top of the can, in order to evenly fill the can with oxide stripped steel powder.

In the arrangement shown in FIG. 3, the oxide stripped steel powder is removed from the hopper via the powder exit port 57 that is provided on the hopper base 48 of the hopper 30, i.e. opening the powder exit port 57 enables the oxide stripped steel powder to drain from the powder hopper due to gravity.

The removal of oxide stripped steel powder can be monitored and controlled by suitable means that are known in the art.

The can provides a mould for the article to be formed from the oxide stripped steel powder. The can is typically manufactured from sheet metal and shaped either for the desired shape of the article or shaped in a shape that approximates the desired shape with the expectation that the desired shape will be obtained once the oxide stripped steel powder has been hot isostatically pressed.

Step (e) 105 of the method 100 of the present disclosure involves converting the steel powder to solid steel by hot isostatic pressing to form the article.

The steel powder can be converted to solid steel by hot isostatic pressing using any suitable hot isostatic pressing method.

The article formed by the method of the present disclosure can removed or separated from the can by any suitable method. For example, the can may be removed by acid pickling or by machining.

### Advantages of the Invention

The method of present disclosure for manufacturing an article, e.g. a vessel, as described above offers various technical advantages. Whilst many of have been described above, in summary such advantages include:

The steel powder has been stripped of oxides in a hopper before it is exposed to any downstream processing such as hot isostatically pressing.

Treating powder in a hopper prior to it being discharged, e.g. poured, into the can of the article to be formed makes it easier to remove any oxide particles or chemical by-products of the oxide stripping process. If not removed such particles/compounds/chemical by-products can compromise the mechanical properties of the article that is manufactured by the method of the present disclosure. That is of particular concern for safety/mission critical applications such as a nuclear reactor pressure vessel when it must be guaranteed that the material properties of the article are at the required level.

A simple hopper shape can be used so that the oxide stripping medium can reach all powder areas easily, and more easily achieve optimal medium flow paths rather than using a can that may be complex in design to achieve a near net shape geometry. The use of a simple hopper shape can avoid or at least minimise the risk of the oxide stripping medium, oxide particles, and compounds/chemical by-products of the oxide stripping process becoming trapped in complex geometries.

FIG. 1 shows an article in the form of a nuclear pressure vessel that has many features such as inlet nozzles 12, outlet nozzles 15, support mounts 21 and lifting lugs 18. The can for such a geometry is therefore rather complex. Thus, if the can was filled with powder and then the oxide stripping process applied, there is the risk that the powder in the complex features will not receive an adequate oxide stripping treatment and also that the oxide particles, the oxide stripping medium and/or compounds/chemical by-products will become trapped in such areas. Hence the properties of the consolidated powder, e.g. after a HIP process, could be inferior to other areas of the article that have been adequately treated and thus the manufactured article is unacceptable. If the powder is treated in the hopper first, as per the method of the present disclosure, e.g. in a simpler shaped hopper, prior to being inserted into the can, the quality of the powder and hence resulting properties of the manufactured can be more easily guaranteed.

By stripping oxides from steel powder in the hopper it is possible to take samples to test that the steel powder has been adequately treated by the oxide stripping medium before the steel powder has been discharged into the can. The steel powder is largely inaccessible once it has been discharged into the can, particularly so when the powder has been discharged into complex areas of the can, especially if the can provides a mould for a large and/or complex article.

It is far easier to check the effectiveness of the oxide stripping process when it is applied to the powder in a hopper rather than in the can. As stated above, it is far easier to take samples and test the treated powder when it is in a hopper than in a can. If it is established, e.g. from sample tests that further treatment is required, the oxide stripping process can be re-applied and subsequent checks conducted and so forth. When the powder is treated in a can, there is a reliance on previous work, e.g. laboratory work, to provide guidance on acceptable parameters, e.g. the time the process should be applied. This guidance could be inaccurate when, e.g. larger quantities of powder are processed compared to the quantity of powder initially assessed in laboratory conditions.

The effectiveness in treating all of the powder can be increased by treating powder in a hopper rather than after it has been filled into a can. The hopper can be subjected to motion to move the powder particles around in the hopper, for example tumbling the powder particles. All of the powder is then more likely to be treated to the same level, whereas when powder has been filled into a can, larger-scale motions of the powder particles, for example tumbling is not possible. Samples can be taken after powder has been moved around in the hopper to provide greater confidence that all of the powder has been treated similarly.

The method of the present disclosure reduces the risk of can distortion or failure during hot isostatic pressing If the medium used to strip the oxide from the powder or the compounds/chemical by-products produced from the application of the oxide-stripping process expand significantly as a result of an increase in temperature, this can result in the volume of same increasing such that the can may distort or fail. The extremely high temperatures used in the HIP process, for example greater than 1000° C., can result in large changes in volume and resulting pressure in the can. For example, when hydrogen gas is used, water is a by-product of the process, and any hydrogen gas and water that is not removed from the can will expand significantly when the temperature is increased in the HIP process. More complex cans with features that could trap the oxide stripping medium and compounds/chemical by-products increase the risk of this occurring. It is extremely difficult to ascertain that there is nothing trapped throughout the can. If a can were to distort or fail the resulting article would most likely need to be scrapped. It is far easier to ensure there is no trapped medium, compounds/chemical by-products by treating the powder in a simple hopper shape that does not have features that could trap same.

Using the at least one hopper as the chamber to which oxide stripping is conducted, not only removes the detriments of applying the process to complex near-nett shape cans, but also means the oxide stripping can be conducted up-stream of when the powder is required for can filling, thus allowing more flexible time management planning. A larger quantity of powder can be treated all at once in a large hopper, and then applied to one, or numerous cans.

For the HIP process it is imperative the can does not fail during the HIP process, else the powder will not consolidate fully, and the article will need to be scrapped. Near-nett shape cans are commonly achieved through complex, welded fabrications, and relative to hoppers, the can material is generally far thinner as it needs to be able to deform without failure to enable the powder inside it to consolidate. A can is therefore more susceptible to any weakening of the can material or the welds as a consequence of the oxide-stripping process being applied, for example weakening caused by the compounds/chemical by-products created in the oxide stripping process, or the temperature.

Powder hoppers for storing/transporting powders are commonly designed to be robust containers to allow for powder to be shipped from powder manufacturer to HIP vendor, so this mitigates potential weaknesses in structural integrity from oxide stripping in cans.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A method for manufacturing an article, the method comprising the steps of:
a) charging at least one hopper with steel powder;
b) supplying an oxide stripping medium to the steel powder in the at least one hopper;
c) removing the oxide stripping medium and any oxide particles stripped from the steel powder from the at least one hopper;
d) discharging the oxide stripped steel powder into a can that provides a mould for the article; and
e) converting the steel powder to solid steel by hot isostatic pressing to form the article.

2. The method of claim 1, wherein the oxide stripping medium is hydrogen gas.

3. The method of claim 1, wherein the at least one hopper is frustoconical in shape.

4. The method of claim 1, wherein the at least one hopper includes a mixing apparatus.

5. The method of claim 1, wherein the at least one hopper is rotatable about an axis.

6. The method of claim 1, wherein the oxide stripping medium and oxide particles stripped from the steel powder are removed from the at least one hopper through an oxide stripping medium and oxide particles exit port formed in the at least one hopper.

7. The method of claim 1, wherein the oxide stripped steel powder is discharged through a powder exit port formed in the at least one hopper into the can.

8. The method of claim 1, wherein the oxide stripped steel powder is discharged from a plurality of hoppers into the can through a plurality of powder exit ports formed in the plurality of hoppers and a plurality of powder inlets formed in the can.

9. The method of claim 8, wherein the powder inlets are substantially equally spaced apart in order to evenly fill the can with the oxide stripped steel powder.

10. The method of claim 1, wherein the article is a vessel.

11. The method of claim 10, wherein the vessel is a nuclear reactor pressure vessel.
